(19) United States
(12) Patent Application Publication
(10) Pub. No.: US 2023/0401911 A1
(43) Pub. Date: Dec. 14, 2023

(54) LIGHTWEIGHT IN-VEHICLE CRITICAL SCENARIO EXTRACTION SYSTEM

(71) Applicant: Mobileye Vision Technologies Ltd., Jerusalem (IL)

(72) Inventors: Qianying Zhu, Beijing (CN); Lidan Zhang, Beijing (CN); Xiangbin Wu, Beijing (CN); Xinxin Zhang, Beijing (CN); Fei Li, Beijing (CN)

(21) Appl. No.: 18/034,232

(22) PCT Filed: Nov. 19, 2021
(86) PCT No.: PCT/IB2021/000803

§ 371 Date: Apr. 27, 2023

(30) Foreign Application Priority Data
Nov. 19, 2020 (WO) PCT/CN2020/130241

(51) Int. Cl. G07C 5/08; G06V 20/58; G07C 5/00

(52) U.S. Cl. CPC G07C 5/085; G06V 20/58; G07C 5/008

(57) ABSTRACT

Various aspects of methods, systems, and use cases for critical scenario identification and extraction from vehicle operations are described. In an example, an approach for lightweight analysis and detection includes capturing data from sensors associated with (e.g., located within, or integrated into) a vehicle, detecting the occurrence of a critical scenario, extracting data from the sensors in response to detecting the occurrence of the critical scenario, and outputting the extracted data. The critical scenario may be specifically detected based on a comparison of the operation of the vehicle to at least one requirement specified by a vehicle operation safety model. Reconstruction and further data processing may be performed on the extracted data, such as with the creation of a simulation from extracted data that is communicated to a remote service.

### PRIORITY CLAIM

This application claims the benefit of priority to International Application No. PCT/CN2020/130241, filed Nov. 19, 2020, which is incorporated herein by reference in its entirety.

### BACKGROUND

Widescale use of autonomous driving (AD) is getting closer, but the safety of autonomous vehicles (AVs) remains a significant challenge. For the foreseeable future, AVs will coexist with human-driven vehicles on roads. However, the behaviors of human-driven vehicles and pedestrians have considerable uncertainties typically because of reckless driving, violating traffic regulations intentionally, negligence, loss of vehicle control, absent-mindedness, and other reasons. These uncertainties will result in many unpredictable and dangerous situations for AVs, referred to herein as “dangerous scenarios” or “critical scenarios.”

These real-life, dangerous situations are very valuable for the development and safety assessment of AVs. With improvement, AVs can learn how to predict and evaluate potential risks on the road and interact with human drivers and pedestrians. However, existing approaches for vehicle operation logging and data capture have encountered a variety of limitations for identifying and capturing critical scenarios of autonomous vehicles, produced from real-world encounters such as accidents, near-misses, hazards, and the like.

### BRIEF DESCRIPTION OF THE DRAWINGS

In the drawings, which are not necessarily drawn to scale, like numerals may describe similar components in different views. Like numerals having different letter suffixes may represent different instances of similar components. Some embodiments are illustrated by way of example, and not limitation, in the figures of the accompanying drawings in which:

FIG. 1 illustrates a system to provide in-vehicle critical scenario extraction, according to an example.

FIG. 2 illustrates a system architecture for in-vehicle critical scenario extraction, according to an example.

FIG. 3 illustrates a processing flow performed for critical scenario extraction, according to an example.

FIG. 4 illustrates camera calibration and coordinate transformation for extracted scenario processing, according to an example.

FIG. 5 illustrates a data stream used for extracted scenario processing, according to an example.

FIG. 6 illustrates an extracted scenario regenerated in a simulator, according to an example.

FIG. 7 illustrates a flowchart of a method for collecting and operating data logging, according to an example.

FIG. 8 illustrates a flowchart of a method for performing critical scenario data identification and extraction, according to an example.

FIG. 9 illustrates a machine in the example form of a computer system, to perform any one of the methodologies discussed herein, according to an example.

### DETAILED DESCRIPTION

The following embodiments generally relate to mechanisms and techniques for identifying and extracting data from scenarios encountered during vehicle operations. Specifically, the following describes a lightweight in-vehicle critical scenario extraction system which can detect dangerous situations from a vehicle road operation in real-time, extract the essential scenario elements, eliminate private or privacy-sensitive information from the raw data, and then upload the extracted scenarios to a cloud server or other external system.

The following provides a low-cost solution to collect data from a variety of real-world dangerous situations in real-time. In the following examples, a lightweight in-vehicle critical scenario extraction system is implemented to detect a dangerous or problematic situation on roads in real-time, buffer data from this scenario, and then ultimately upload a specification of the scenario to a cloud server at a remote location. The scenario specification can be used to re-generate a critical scenario in a simulation platform for repeated test and evaluation. The scenario data elements may include information relating to velocities, trajectories, orientations and locations of the ego-vehicle and other surrounding vehicles and pedestrians. These scenario data elements can be regenerated in a simulator for AV training and test outcomes.

The following infrastructure for essential scenario analysis provides significant advantages. First, the lightweight in-vehicle critical scenario extraction system can be implemented as an independent hardware device or component, or integrated with an existing in-vehicle device or computer system, e.g., with dash cameras or Advanced Driver Assistance System (ADAS) components. As a result, this critical scenario extraction system can be adopted and deployed quickly into a variety of vehicle types. Additionally, with the collected real-time traffic accident (dangerous situation) information (accident category, location, timeslot, road/weather condition etc.), a traffic accident map can be constructed, overlaying information on an AV map or on an HD map used by AVs. The traffic accident map can be used to adjust the safety operation parameters of AVs (e.g., parameters for responsibility sensitive safety (RSS) safety operations), or generate a precaution or warning message to other AVs.

With existing approaches, some autonomous driving companies have used specially designed vehicles (e.g., equipped with an on-board data acquisition system and specially designed sensors) to collect high-accuracy vehicle kinematics during driving and then filter out dangerous situations offline. However, this processing approach has some clear disadvantages. First, the data acquisition system has a high cost, and usually requires specially trained drivers to drive the car, which results in a very limited amount of data acquisition. Additionally, the data acquisition vehicles usually drive in a relatively fixed city area day by day, and are unlikely to encounter and capture critical scenarios. Finally, the limited number of vehicles plus limited operation in a relatively fixed city area, results in many of the scenarios collected not being representative of broader real world conditions. In fact, the driving scenarios collected by specially designed vehicles may even have significant differences simply when collected in different areas or during different time slots.

Prior approaches for analyzing critical scenarios generally fit into one of the following categories. First, some approaches utilize a runtime log. Some vehicles classified at Level 2 (L2, partial driving automation with ADAS) or above have a log mechanism to record some system runtime parameters and status data, e.g., Tesla's ‘TeslaLog’. The log data can be uploaded to the vehicle manufacturer for later analysis. However, such a runtime log produces log data that is merely designed for malfunction analysis of an ego vehicle. The data collected in this runtime log cannot record an entire traffic accident and cannot be used to regenerate the critical scenario in a simulator.

Another prior approach for analyzing critical scenarios involves the use of a naturalistic driving study. As noted above, some autonomous driving companies and research institutions use specific vehicles equipped with an on-board data acquisition system to collect high-accuracy vehicle kinematics during daily driving, and then filter out critical scenarios. However, the specific data acquisition system often has a high cost with expensive sensors (Lidar, radar . . . ) and storage, and requires specific vehicles and drivers, which results in limited usage that cannot be widely adopted and deployed. Further, the collected raw data from these vehicles contains large amounts of privacy-sensitive information, including license plate and facial information of pedestrians. The volume of raw data is huge and also provides a large burden for wireless data upload. The raw data requires huge local/cloud storage space, however most of the collected data is useless and has a lack of critical scenarios.

A final prior approach for analyzing critical scenarios involves the use of a traffic accident investigation report. For instance, if an accident occurs with an AV, a government transport research institution may investigate the accident scene and reconstruct it for accident analysis. The investigation report is usually brief and used for statistical analysis. From this, the simulation working condition parameters are extracted from the accident and used to reproduce a collision accident simulation. However, when using a traffic accident investigation report, the report is based on the outcome of the accident scene which cannot describe the whole process of the accident and the entire critical scenario for AV operation. Further, collision simulation with the extracted working condition parameters are only used for vehicle dynamics simulation and cannot be used for testing of AV operational algorithms. To test the autonomous vehicle system (AVS) which typically includes a perception module, prediction module, motion planning modules, etc., a complete driving scenario including static elements and dynamic element, and working condition parameters, must be considered.

The following in-vehicle critical scenario extraction system emphasizes a number of lightweight elements, to enable wide adoption and deployment. This solution can dynamically collect accident data and grow a simulation scenario library by offering many number and categories of accidents and incidents, based on data collected from a large number of vehicles running on the road all the time. Among other benefits, the following approaches can greatly reduce the requirement for storage space either in cloud or in vehicle (and utilization of wireless bandwidth), because only critical scenario data is saved and uploaded to the cloud, and redundant data can be discarded before uploaded. Additionally, the following approaches provide an improved protection of privacy. Private or sensitive information can be eliminated in vehicle, so that only anonymous scenario information is uploaded to the cloud.

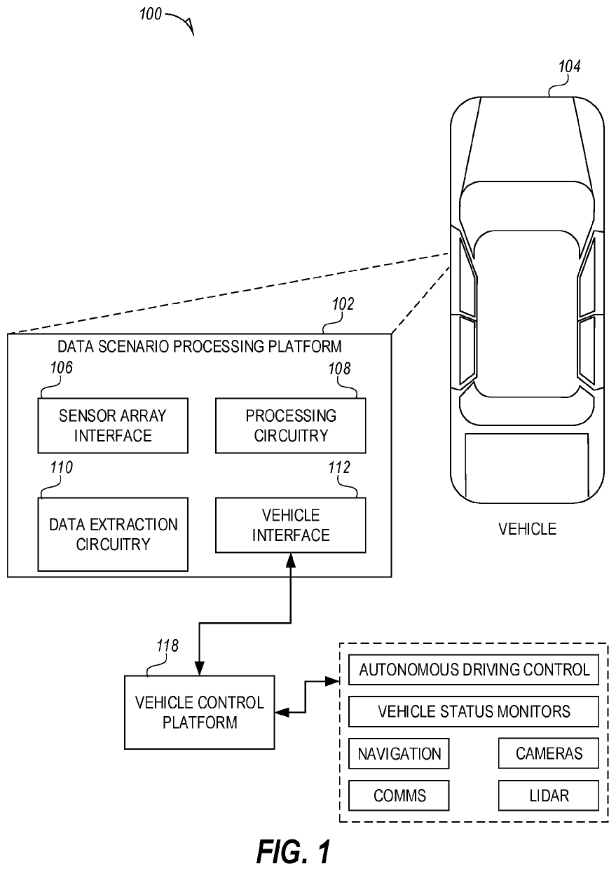

FIG. 1 is a schematic drawing illustrating a system 100 to provide vehicle critical scenario extraction, according to an embodiment. FIG. 1 includes a data scenario processing platform 102 incorporated into the vehicle 104. The data scenario processing platform 102 includes a sensor array interface 106, processing circuitry 108, data extraction circuitry 110, and a vehicle interface 112.

The vehicle 104, which may also be referred to as an “ego vehicle” or “host vehicle”, may be any type of vehicle, such as a commercial vehicle, a consumer vehicle, a recreation vehicle, a car, a truck, a motorcycle, a boat, a drone, a robot, an airplane, a hovercraft, or any mobile craft able to operate at least partially in an autonomous mode or while utilizing autonomous driving features. The vehicle 104 may operate at some times in a manual mode where the driver operates the vehicle 104 conventionally using pedals, a steering wheel, or other controls. At other times, the vehicle 104 may operate in a fully autonomous mode, where the vehicle 104 operates without user intervention. In addition, the vehicle 104 may operate in a semi-autonomous mode, where the vehicle 104 controls many of the aspects of driving, but the driver may intervene or influence the operation using conventional (e.g., steering wheel) and non-conventional inputs (e.g., voice control). In this fashion, the vehicle may operate at the same or different times among any number of driving automation levels, defined from Level 1 to Level 5 (e.g., as defined by SAE International J3016: Level 1, Driver Assistance; Level 2, Partial Driving Automation; Level 3, Conditional Driving Automation; Level 4, High Driving Automation; Level 5, Full Driving Automation). The vehicle may also operate using combinations or variations of these levels. For instance, the vehicle may operate according to a new concept, L2+(Level 2 Plus), which describes a type of hybrid ADAS/AV to facilitate enhanced driving experience and boost safety without the need to provide a fully autonomous control system.

The sensor array interface 106 may be used to provide input or output signaling to the data scenario processing platform 102 from one or more sensors of a sensor array installed on (within) the vehicle 104. Examples of sensors include, but are not limited to: forward, side, or rearward facing cameras; radar; LiDAR; ultrasonic distance measurement sensors; or other sensors. Forward-facing or front-facing is used in this document to refer to the primary direction of travel, the direction the seats are arranged to face, the direction of travel when the transmission is set to drive, or the like. Conventionally then, rear-facing or rearward-facing is used to describe sensors that are directed in a roughly opposite direction than those that are forward or front-facing. It is understood that some front-facing cameras may have a relatively wide field of view, even up to 180-degrees. Similarly, a rear-facing camera that is directed at an angle (perhaps 60-degrees off center) to be used to detect traffic in adjacent traffic lanes, may also have a relatively wide field of view, which may overlap the field of view of the front-facing camera. Side-facing sensors are those that are directed outward from the sides of the vehicle 104. Cameras in the sensor array may include infrared or visible light cameras, able to focus at long-range or short-range with narrow or large fields of view. The vehicle 104 may also include various other sensors, such as driver identification sensors (e.g., a seat sensor, an eye tracking and identification sensor, a fingerprint scanner, a voice recognition module, or the like), occupant sensors, or various environmental sensors to detect wind velocity, outdoor temperature, barometer pressure, rain/moisture, or the like.

Sensor data is used to determine the vehicle's operating context, environmental information, road conditions, travel conditions, or the like. The sensor array interface 106 may communicate with another interface, such as an onboard navigation system, of the vehicle 104 to provide or obtain sensor data. Components of the data scenario processing platform 102 may communicate with components internal to the data scenario processing platform 102 or components that are external to the platform 102 using a network, which may include local-area networks (LAN), wide-area networks (WAN), wireless networks (e.g., 802.11 or cellular network), ad hoc networks, personal area networks (e.g., Bluetooth), vehicle-based networks (e.g., Controller Area Network (CAN) BUS), or other combinations or permutations of network protocols and network types. The network may include a single local area network (LAN) or wide-area network (WAN), or combinations of LANs or WANs, such as the Internet. The various devices coupled to the network may be coupled to the network via one or more wired or wireless connections.

The data scenario processing platform 102 may communicate with a vehicle control platform 118. The vehicle control platform 118 may be a component of a larger architecture that controls various aspects of the vehicle's operation. The vehicle control platform 118 may have interfaces to autonomous driving control systems (e.g., steering, braking, acceleration, etc.), comfort systems (e.g., heat, air conditioning, seat positioning, etc.), navigation interfaces (e.g., maps and routing systems, positioning systems, etc.), collision avoidance systems, communication systems, security systems, vehicle status monitors (e.g., tire pressure monitor, oil level sensor, battery level sensor, speedometer, etc.), and the like. The vehicle control platform 118 may control or monitor one or more subsystems, and communicate data from such subsystems to the data scenario processing platform 102. In an example, the processed results from the sensors provide an “environmental model” for operation of the vehicle. Such an environmental model may represent information for each time-frame that the environmental model is at a given state, and for each state that there is an action that is selected based on the given state.

In an example, sensor data, such as braking, throttle, speed data signals, among other data signal types, may be provided to the data classification circuitry 110, which may preprocess the input signals. The data extraction circuitry 110 may implement various rules, algorithms, or logic, including one of several types of machine learning, such as artificial neural networks (ANN), support vector machines (SVM), Gaussian mixture model (GMM), deep learning, or the like. Based on the possible classification or data value identification, the processing circuitry 108 may initiate one or more responsive data processing, logging, or communication activities. Other autonomous vehicle and data processing actions may be monitored, coordinated, or initiated depending on the type, severity, location, or other aspects of an event detected with the data scenario processing platform 102.

In an example, the data scenario processing platform 102 may be used to extract scenario elements in real-time, or in a batch mode in certain period (e.g. daily) or under certain conditions (e.g. a threshold of available disk usage). The data scenario processing platform 102 may be accompanied by a communication interface between a vehicle and the cloud server allows to exchange data which is used to re-generate a virtual scenario in simulator. The data scenario processing platform 102 may also implement, display, or update a real-time accident map (with locations, accident categories etc.) used to adjust the safety model operation parameters of the AV, or generate a warning or alert message to other AVs, take other steps to enhance the safety and performance of the AV.

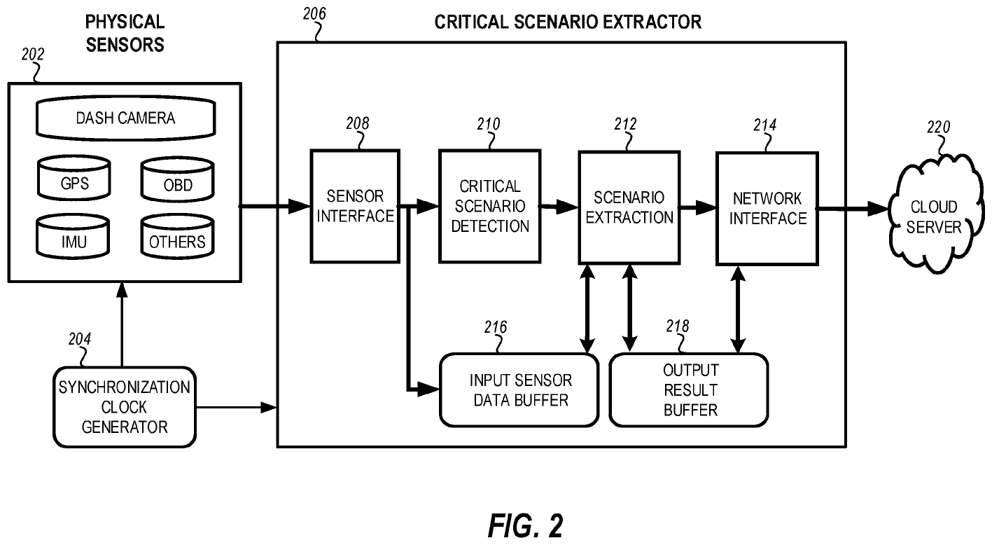

FIG. 2 depicts a system architecture for in-vehicle critical scenario extraction, such as may be implemented by a critical scenario extraction system 206 operating within the platform 102 and vehicle 104. As shown, the critical scenario extractor includes a processing pipeline with a sensor interface 208, critical scenario detection 210, scenario extraction 212, and network interface module 214. Additional elements and processing modules may also be incorporated into this architecture.

The sensor interface 208 may connect to various types of physical sensors 202, including inexpensive and widely used sensors which can capture data on the scenarios and the environment of the vehicle operation. In an example, sensors 202 may collect and provide data from: Dash cameras that record the whole process of the accident or incident, including all dynamic elements (vehicles, pedestrians) and static elements (weather, buildings, trees, traffic lights, etc.) surrounding the vehicle; GPS sensors that provide the location information of the scenario, which can be later used to retrieve the HD map/road mesh of the accident scene from commercial/open source HD map providers (e.g., OpenStreetMap), or used to build a real-time traffic accident or incident map; an IMU (an inertial measurement unit), which can be used for localization together with GPS, and which can also provide the vehicle acceleration and orientation information; and OBD (On Board Diagnostics), which can obtain and provide precise vehicle dynamic information from various vehicle subsystems, including data related to the velocity, throttle, brake, wheeling, etc. of the vehicle.

In an example, the GPS/OBD/IMU data are sampled at the frame rate of the dash camera. The sensor interface module 208 is used to receive and process the incoming data from the above referenced physical sensors, and other auxiliary sensors. These sensors can be exclusively utilized by the critical scenario extraction system 206, or can be shared between the system and other in-vehicle devices (e.g., ADAS systems).

The critical scenario detection module 210 may be used to detect a variety of dangerous or hazardous situations, referred to herein as a “critical” scenario. Such hazardous or dangerous situations may include those in which the ego vehicle may make (or has made) an unsafe decision that is going to lead to an accident, or in which the ego vehicle can be involved and must take appropriate countermeasures to avoid an imminent collision or other loss. According to the detection result, two signals will be asserted and passed down to other modules:
1) Critical_scenario_detected. This signal indicates that a dangerous or hazardous situation is detected. Multiple criteria (or a single criterion) can be used to trigger the signal, including but not limited to: (a) Lateral or longitudinal acceleration is higher than a threshold; (b) Time-to-collision (TTC) is less than a threshold; (c) A violation to one or more safety policies has been detected (e.g., a violation of the Responsibility-Sensitive Safety (RSS) model as defined by Mobileye, or a violation or dangerous condition of other vehicle operational safety models, such as those mandated or required by standards bodies or government jurisdictions). In a specific example, a critical scenario is determined by observing a current or a next state of the host vehicle relative to at least one target object and estimating that some dangerous outcome (e.g., an accident) cannot be avoided. In another specific example, a critical scenario is determined when the state of the host vehicle is such that at least one safety rule or criteria (of the safety policy) is compromised and cannot be followed.
2) Critical scenario exit. The signal indicates a dangerous situation is finished. Some criteria can be used to trigger the signal, including but not limited to: (a) The velocity of the ego-vehicle is less than a threshold; (b) A collision has been detected; (c) The violation to one or more safety policies has been eliminated. In order to completely record the critical scenario, the starting time of the scenario should be some seconds earlier than Critical_scenario_detected signal is asserted; and the ending time of the scenario should be some seconds later than Critical scenario exit signal is asserted.

Based on the results of the critical scenario detection module 210, the scenario extraction module 212 is activated. If a critical scenario is detected, this scenario extraction module 212 will read out raw sensor data from a global data buffer and extract the critical scenario elements from it, including velocities, trajectories, locations and rotations of all road participants. The extracted elements can be organized in different format. Privacy or sensitive information may also be removed by the scenario extraction module 212, such as through the use of anonymization or data obfuscation processes which removes information which may identify the host vehicle.

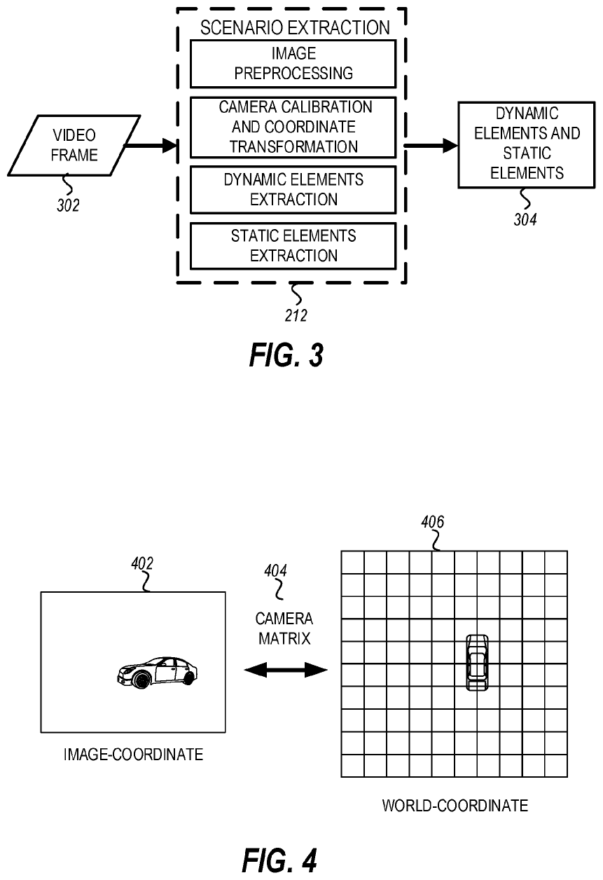

FIG. 3 provides a more detailed overview of the processing flow performed by the scenario extraction module 212. In an example, the scenario extraction module 212 reads in a video frame 302 and then extracts the elements 304 to be used for scenario reconstruction in the cloud, including dynamic elements (e.g., vehicle/walker trajectory, velocity, location, rotation, etc.) and static elements (e.g., traffic lights, surroundings, weather etc.). These elements 304, in some examples, may be signatures or otherwise compact representations of the objects in the environment, rather than raw data or another type of high-resolution (data intensive) representation.

Other operations performed by the scenario extraction module 212, and depicted in FIG. 3, include: (a) Image pre-processing (e.g., to enhance the video frame, adjust its luminance, size, eliminate lens distortion etc.); (b) camera calibration and coordinate transformation (e.g., to perform camera calibration automatically and compute the extrinsic and intrinsic parameters of the camera, including the focal length, the skew coefficient, the rotation and translation); (c) Dynamic elements extraction (e.g., to perform state-of-art object detection and tracking algorithms to detect, classify and track each vehicle/pedestrian in each video frame, and then extract its model, location, rotation, velocity and trajectory); and (d) Static elements extraction (e.g., by extracting static elements (road mesh, surroundings, traffic lights, weather) directly from the video frame through computer vision algorithms in the device; by using GPS localization to retrieve the road mesh and other static elements from open source/commercial HD map data in the cloud; or by a fusion of static and dynamic methods, such as by retrieving road mesh in cloud and extract other static elements in device side).

FIG. 4 provides an illustration of camera calibration and coordinate transformation. The camera calibration may be performed automatically to compute the extrinsic and intrinsic parameters of the camera, based on parameters such as focal length, skew coefficient, rotation, and translation. These parameters can also be acquired from the camera vendor directly. In various examples, use of this camera calibration procedure and accompanying hardware (e.g., a calibration module) can be disabled or bypassed. In an example, with the camera parameters, each pixel in the 2D video image 402 from a camera matrix 404 (in an image coordinate system) can be mapped to a point in the 3D space 406 (in a world coordinate system).

Returning to FIG. 2, the scenario elements will be first combined with metadata (e.g., including those produced by the elements 304), and then will be uploaded to cloud server 220 through network interface 214. Each data chunk (a “data frame”) is organized per video frame and saved into an output buffer sequentially, and finally packed and uploaded to the cloud server 220.

In an example, the scenario extraction module 212 is operably coupled to an input sensor data buffer 216. The input sensor data buffer 216 is a cyclic buffer which is used to store input raw data from sensors, including video frames, or GPS/OBD/IMU data. All data is aligned by video frame (e.g., based on the synchronization clock generator 204). Such input data can be processed in real-time. As will be understood, the buffer needs to buffer at least several seconds of sensor data, and therefore the buffer can be implemented using volatile memory (e.g., DDR SDRAM).

Also in an example, the scenario extraction module 212 is operably coupled to an output result buffer 218. The output result buffer 218 is also a cyclic buffer which is used to store the extracted scenario elements and metadata. All data is aligned by video frame (e.g., based on the synchronization clock generator 204). The output result buffer 218 may need to buffer extracted scenarios during a longer pre-defined time period (e.g., several days or weeks), and thus this buffer should be implemented using non-volatile storage (SD card, parallel Flash, etc.). The scenario data in this buffer will be uploaded to the cloud server 220 though a wireless network, or the data can be read out directly from the non-volatile storage through a special wired/cable interface (e.g., USB interface). If no available network connection is found, the data will be kept in the buffer until it is uploaded.

In an example, the data frame is provided from the output result buffer 218 in the following format:

TABLE 1

#--------- per-scenario metadata ---
Scenario sequence ID
Scenario time
Device ID
Total frame number
Ego vehicle model
#--------- per-video-frame metadata ---
Frame Timestamp
Frame sequence ID
NPC total number
GPS data synchronized with current video frame
OBD data synchronized with current video frame
IMU data synchronized with current video frame
#--------- per-video-frame scenario elements ---
Ego vehicle dynamic data: location/rotation/velocity
NPC 1 dynamic data: location/rotation/velocity
...
NPC N dynamic data: location/rotation/velocity
Weather description: Sun/Fog/Precipitation
Surrounding object 1: location/classification/bounding box ...
...
Surrounding object N: location/classification/bounding box ...
Traffic light: location/status

A data transmission module (not shown, but potentially implemented by network interface module 214) is responsible for uploading the extracted scenario data to the cloud server 220. Its implementation depends on the wireless communication technology selected (IEEE 802.11/Wi-Fi, 5G, etc.). The major functionalities of a data transmission model may include: (a) Setup of a safe (secure, trusted) connection between device and the cloud server 220; (b) Functionality to segment the scenario data and encapsulate the scenario data into network packets; and (c) Data encryption and transmission/retransmission (e.g., by implementation of an IPSec protocol). An external network transmission module or integrated IP (network interface circuitry) can be employed for data transmission.

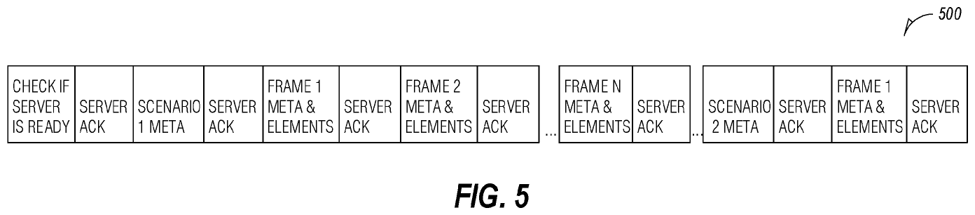

FIG. 5 provides an illustrative example of a data stream 500. In this data stream, the following sequence of events occurs.)
1) Device first sends a packet to cloud server to check if the server or service is ready for receiving data.
2) Device waits until it receives server's ACK. If no ACK is received in a defined time slot, return to step 1.
3) Device sends the scenario metadata to the cloud server.
4) Device waits until it receives the server's ACK. If no ACK is received in a defined time slot, return to step 3.
5) Device sends out the frame meta data and data elements to the cloud server.
6) Device waits until it receives the server's ACK. If no ACK received in a defined time slot, return to step 5.
7) Device sends out next scenario metadata.

When a scenario is uploaded successfully, the data for the scenario will be removed from the local output result buffer.

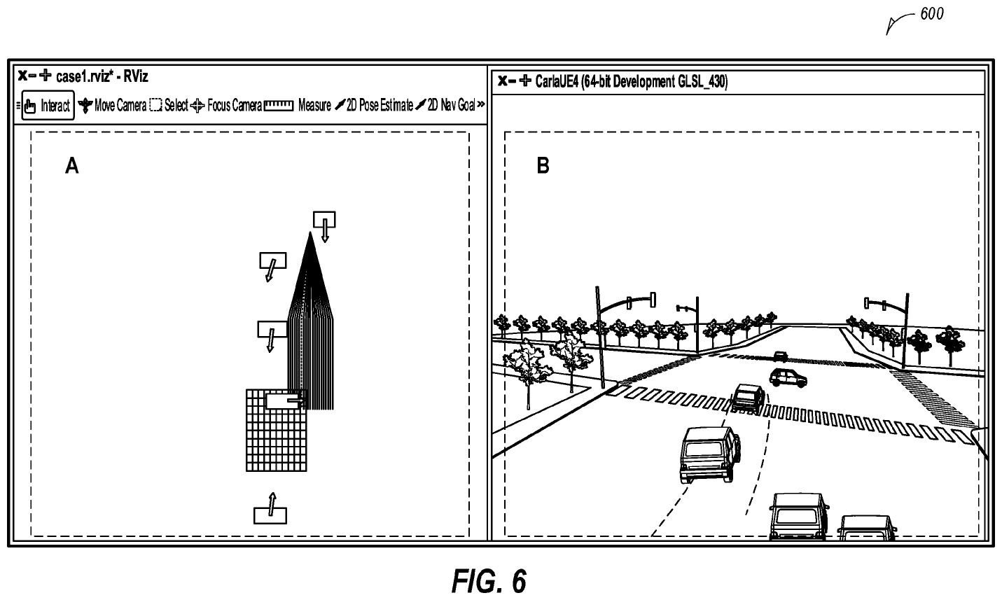

FIG. 6 depicts an extracted scenario 600 which is regenerated in a simulator (e.g., CARLA open source simulator) for virtual test and algorithm development. If a same event is captured and uploaded by multiple involved vehicles during road operation, the scenario specifications for the event can be merged to a more complete scenario in the cloud server 220.

Another application, not depicted, may be provided as part of a system for hosting and generating a real-time traffic accident map. Such an accident map can be used to adjust the vehicle operational safety model (e.g., RSS model) parameters of AVs, or generate a warning, precaution, or alert message to other AVs.

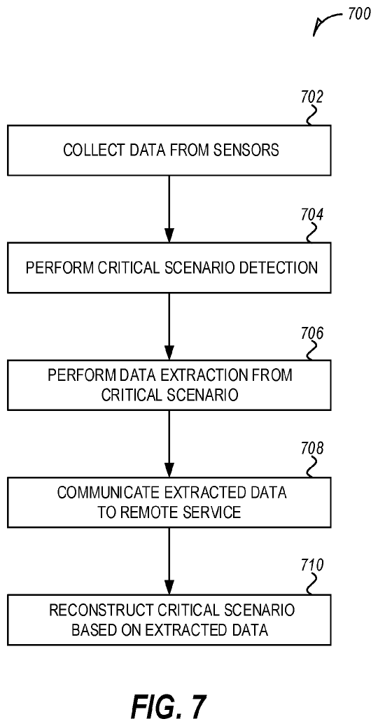

FIG. 7 depicts a flowchart 700 of a method for collecting and identifying critical scenario data, according to the present techniques.

Operation 702 involves collecting data from sensors (e.g., physical sensors 202, as discussed above), including from use of the lightweight sensor platforms. From the sensors, an ongoing stream of data may provide operational data values and telemetry, including for use with an input buffer as discussed above.

Operation 704 involves performing critical scenario detection on the collected data. Specific classification and identification collected data values and conditions may be performed as discussed above. In various examples, this critical scenario may be tied to conditions or events of a vehicle operation safety model (e.g., an RSS model).

Operation 706 includes performing data extraction from the critical scenario, including extraction of data from relevant data sensors. Such data may include the extraction of static elements and the extraction of dynamic elements, as discussed with reference to FIG. 3. In further examples, an environmental model is also extracted together with the safety model parameters. Additional aspects of metadata processing and coordinate space processing may be performed, as discussed with reference to FIG. 4.

Operation 708 includes communicating the extracted data to a server or service. Such communications may be performed according to the format and acknowledgement discussed with reference to FIG. 5.

Operation 710 includes reconstructing the critical scenario, based on the extracted data. Other data processing operations discussed herein may also be conducted.

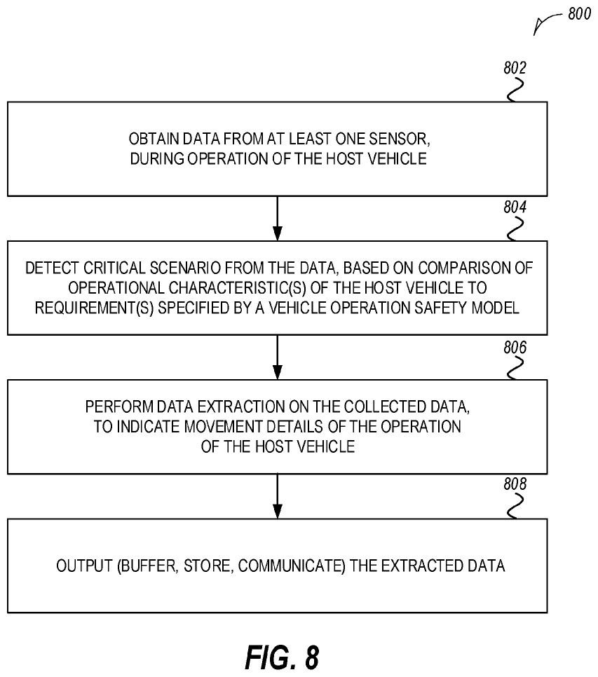

FIG. 8 illustrates a flowchart 800 of a method for performing critical scenario data identification and extraction. The operations of this method may be performed in a lightweight standalone device, a device integrated within or as part of a host or subject vehicle, as part of an automated data logging system, as part of another monitoring or sensing device, or as part of instructions from a computing machine- or device-readable storage medium which are executed by circuitry of the computing machine or device.

At 802, operations are performed including obtaining data from at least one sensor, with the data being produced during operation of the vehicle.

As discussed above, the data obtained from the at least one sensor may be buffered in an input sensor data buffer, and the input sensor data buffer may maintain such data for a defined period (e.g., window) of time. Consistent with the examples above, the data may be provided from at least two sensor systems provided from among: a camera mounted within an interior cabin of the vehicle (e.g., dash cam) which provides image data; a camera integrated within the vehicle (e.g., forward, side, or rear facing camera) which provides image data; a global navigation satellite system (e.g., GPS system) which provides location data; an inertial measurement unit which provides movement data; or an on-board diagnostic system integrated within the vehicle which provides diagnostic data. In further examples, the operations at 802 may also include or be coordinated with synchronizing the data provided from the at least two sensor systems.

At 804, operations are performed including detecting a critical scenario from the data obtained from the at least one sensor, such as with the critical scenario being detected based on a comparison of the operation of the vehicle to at least one requirement specified by a vehicle operation safety model (e.g., RSS model). In an example, the critical scenario is determined to begin upon detection of a violation to the at least one requirement of the vehicle operation safety model, and the critical scenario is determined to end upon elimination of the violation to the at least one requirement of the vehicle operation safety model.

At 806, operations are performed including data extraction on the data obtained from the at least one sensor, in response to detecting the critical scenario, to produce extracted data. Such data extraction may obtain data indictive of movement details of the operation of the vehicle, and other details in connection with the surrounding environment. In an example, the data extraction is started on data captured at a first time in which the critical scenario is determined to begin, and the data extraction is ended on data captured at a second time in which the critical scenario is determined to end. For example, the critical scenario may be determined to begin based on detection of on at least one of: a longitudinal distance between the vehicle and another vehicle being less than a defined value; a lateral distance between the vehicle and another vehicle being less than a defined value; a lateral or longitudinal acceleration of the vehicle being more than a threshold value; or a time-to-collision of the vehicle with an object being less than a defined value. Also for example, the critical scenario may be determined to end based on detection of on at least one of: a longitudinal distance between the vehicle and another vehicle being more than a defined value; a lateral distance between the vehicle and another vehicle being more than a defined value; a lateral or longitudinal acceleration of the vehicle being less than a threshold value; or a detection of a collision of the vehicle with an object.

At 808, operations are performed including the output of the extracted data, such as the buffering, storing, or communication of the extracted data. For instance, outputting the extracted data may include storage of the extracted data in an output result buffer. Such extracted data may be stored in the output result buffer without identifying information of the vehicle (e.g., after removing the identifying information, such as a result of anonymization or data removal operations). In further examples, the output of the extracted data includes communicating the extracted data stored (queued) in the output result buffer to a remote service. Consistent with the examples above, the extracted data may provide information for reconstruction of the critical scenario in a simulation, and the extracted data may provide information that indicates velocities, trajectories, or locations of a plurality of road participants (including the vehicle) involved in the critical scenario.

Embodiments may be implemented in one or a combination of hardware, firmware, and software. Embodiments may also be implemented as instructions stored on a machine-readable storage device, which may be read and executed by at least one processor to perform the operations described herein. A machine-readable storage device may include any non-transitory mechanism or medium for storing information in a form readable by a machine (e.g., a computer). For example, a machine-readable storage device may include read-only memory (ROM), random-access memory (RAM), magnetic disk storage media, optical storage media, flash-memory devices, and other storage devices and media.

A processor subsystem may be used to execute the instruction on the machine-readable medium. The processor subsystem may include one or more processors, each with one or more cores. Additionally, the processor subsystem may be disposed on one or more physical devices. The processor subsystem may include one or more specialized processors, such as a graphics processing unit (GPU), a digital signal processor (DSP), a field programmable gate array (FPGA), or a fixed function processor.

Examples, as described herein, may include, or may operate on, logic or a number of components, modules, or mechanisms. Modules may be hardware, software, or firmware communicatively coupled to one or more processors in order to carry out the operations described herein. Modules may be hardware modules, and as such modules may be considered tangible entities capable of performing specified operations and may be configured or arranged in a certain manner. In an example, circuits may be arranged (e.g., internally or with respect to external entities such as other circuits) in a specified manner as a module. In an example, the whole or part of one or more computer systems (e.g., a standalone, client or server computer system) or one or more hardware processors may be configured by firmware or software (e.g., instructions, an application portion, or an application) as a module that operates to perform specified operations. In an example, the software may reside on a machine-readable medium. In an example, the software, when executed by the underlying hardware of the module, causes the hardware to perform the specified operations. Accordingly, the term hardware module is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which modules are temporarily configured, each of the modules need not be instantiated at any one moment in time. For example, where the modules comprise a general-purpose hardware processor configured using software; the general-purpose hardware processor may be configured as respective different modules at different times. Software may accordingly configure a hardware processor, for example, to constitute a particular module at one instance of time and to constitute a different module at a different instance of time. Modules may also be software or firmware modules, which operate to perform the methodologies described herein.

Circuitry or circuits, as used in this document, may comprise, for example, singly or in any combination, hardwired circuitry, programmable circuitry such as computer processors comprising one or more individual instruction processing cores, state machine circuitry, and/or firmware that stores instructions executed by programmable circuitry. The circuits, circuitry, or modules may, collectively or individually, be embodied as circuitry that forms part of a larger system, for example, an integrated circuit (IC), system on-chip (SoC), desktop computers, laptop computers, tablet computers, servers, smart phones, etc.

As used in any embodiment herein, the term “logic” may refer to firmware and/or circuitry configured to perform any of the aforementioned operations. Firmware may be embodied as code, instructions or instruction sets and/or data that are hard-coded (e.g., nonvolatile) in memory devices and/or circuitry.

“Circuitry,” as used in any embodiment herein, may comprise, for example, singly or in any combination, hardwired circuitry, programmable circuitry, state machine circuitry, logic and/or firmware that stores instructions executed by programmable circuitry. The circuitry may be embodied as an integrated circuit, such as an integrated circuit chip. In some embodiments, the circuitry may be formed, at least in part, by the processor circuitry executing code and/or instructions sets (e.g., software, firmware, etc.) corresponding to the functionality described herein, thus transforming a general-purpose processor into a specific-purpose processing environment to perform one or more of the operations described herein. In some embodiments, the processor circuitry may be embodied as a stand-alone integrated circuit or may be incorporated as one of several components on an integrated circuit. In some embodiments, the various components and circuitry of the node or other systems may be combined in a system-on-a-chip (SoC) architecture. In other examples, the processing circuitry may be embodied or provided by a data processing unit (DPU), infrastructure processing unit (IPU), acceleration circuitry, or combinations of graphical processing units (GPUs) or programmed FPGAs.

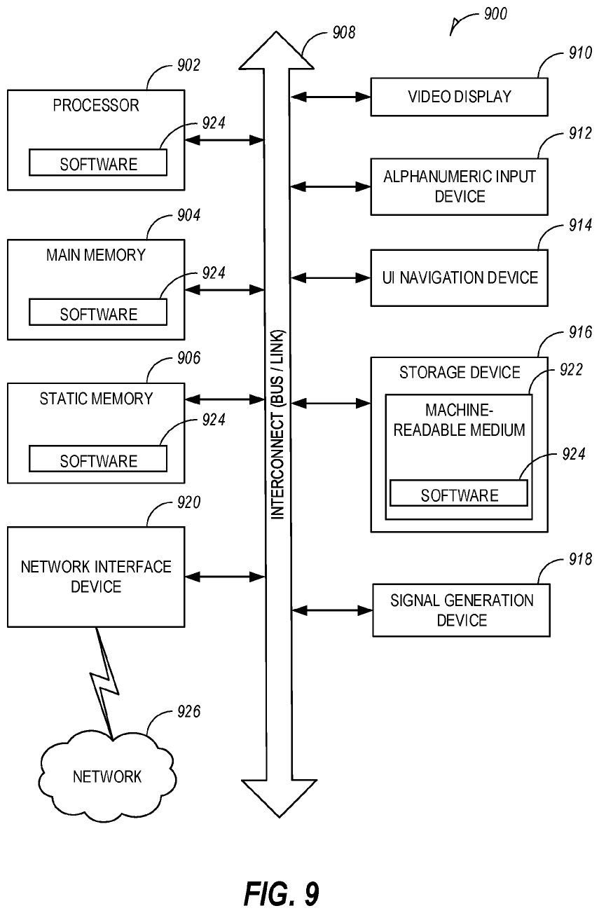

FIG. 9 is a block diagram illustrating a machine in the example form of a computer system 900, within which a set or sequence of instructions may be executed to cause the machine to perform any one of the methodologies discussed herein, according to an embodiment. In alternative embodiments, the machine operates as a standalone device or may be connected (e.g., networked) to other machines. In a networked deployment, the machine may operate in the capacity of either a server or a client machine in server-client network environments, or it may act as a peer machine in peer-to-peer (or distributed) network environments. The machine may be a vehicle subsystem or vehicle on-board computer, a personal computer (PC), a tablet PC, a hybrid tablet, a personal digital assistant (PDA), a mobile telephone or smartphone, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein. Similarly, the term “processor-based system” shall be taken to include any set of one or more machines that are controlled by or operated by a processor (e.g., a computer) to individually or jointly execute instructions to perform any one or more of the methodologies discussed herein.

Example computer system 900 includes at least one processor 902 (e.g., a central processing unit (CPU), a graphics processing unit (GPU) or both, processor cores, compute nodes, etc.), a main memory 904 and a static memory 906, which communicate with each other via a link 908 (e.g., bus). The computer system 900 may further include a video display unit 910, an alphanumeric input device 912 (e.g., a keyboard), and a user interface (UI) navigation device 914 (e.g., a mouse). In one embodiment, the video display unit 910, input device 912 and UI navigation device 914 are incorporated into a touch screen display. The computer system 900 may additionally include a storage device 916 (e.g., a drive unit), a signal generation device 918 (e.g., a speaker), a network interface device 920, and one or more sensors (not shown), such as a global positioning system (GPS) sensor, compass, accelerometer, gyrometer, magnetometer, or other sensor.

The storage device 916 includes a machine-readable medium 922 on which is stored one or more sets of data structures and instructions 924 (e.g., software) embodying or utilized by any one or more of the methodologies or functions described herein. The instructions 924 may also reside, completely or at least partially, within the main memory 904, static memory 906, and/or within the processor 902 during execution thereof by the computer system 900, with the main memory 904, static memory 906, and the processor 902 also constituting machine-readable media.

While the machine-readable medium 922 is illustrated in an example embodiment to be a single medium, the term “machine-readable medium” may include a single medium or multiple media (e.g., a centralized or distributed database, and/or associated caches and servers) that store the one or more instructions 924. The term “machine-readable medium” shall also be taken to include any tangible medium that is capable of storing, encoding or carrying instructions for execution by the machine and that cause the machine to perform any one or more of the methodologies of the present disclosure or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including but not limited to, by way of example, semiconductor memory devices (e.g., electrically programmable read-only memory (EPROM), electrically erasable programmable read-only memory (EEPROM)) and flash memory devices; magnetic disks such as internal hard disks and removable disks; magneto-optical disks; and CD-ROM and DVD-ROM disks.

The instructions 924 may further be transmitted or received over a communications network 926 using a transmission medium via the network interface device 920 utilizing any one of a number of well-known transfer protocols (e.g., HTTP) Examples of communication networks include a local area network (LAN), a wide area network (WAN), the Internet, mobile telephone networks, plain old telephone (POTS) networks, and wireless data networks (e.g., Bluetooth, Wi-Fi, 3G, and 4G LTE/LTE-A, 5G, DSRC, or like networks). The term “transmission medium” shall be taken to include any intangible medium that is capable of storing, encoding, or carrying instructions for execution by the machine, and includes digital or analog communications signals or other intangible medium to facilitate communication of such software.

In an example, information stored or otherwise provided on a machine-readable medium may be representative of instructions, such as instructions themselves or a format from which the instructions may be derived. This format from which the instructions may be derived may include source code, encoded instructions (e.g., in compressed or encrypted form), packaged instructions (e.g., split into multiple packages), or the like. The information representative of the instructions in the machine-readable medium may be processed by processing circuitry into the instructions to implement any of the operations discussed herein. For example, deriving the instructions from the information (e.g., processing by the processing circuitry) may include: compiling (e.g., from source code, object code, etc.), interpreting, loading, organizing (e.g., dynamically or statically linking), encoding, decoding, encrypting, unencrypting, packaging, unpackaging, or otherwise manipulating the information into the instructions.

In an example, the derivation of the instructions may include assembly, compilation, or interpretation of the information (e.g., by the processing circuitry) to create the instructions from some intermediate or preprocessed format provided by the machine-readable medium. The information, when provided in multiple parts, may be combined, unpacked, and modified to create the instructions. For example, the information may be in multiple compressed source code packages (or object code, or binary executable code, etc.) on one or several remote servers. The source code packages may be encrypted when in transit over a network and decrypted, uncompressed, assembled (e.g., linked) if necessary, and compiled or interpreted (e.g., into a library, stand-alone executable, etc.) at a local machine, and executed by the local machine.

It should be understood that the functional units or capabilities described in this specification may have been referred to or labeled as components or modules, in order to more particularly emphasize their implementation independence. Such components may be embodied by any number of software or hardware forms. For example, a component or module may be implemented as a hardware circuit comprising custom very-large-scale integration (VLSI) circuits or gate arrays, off-the-shelf semiconductors such as logic chips, transistors, or other discrete components. A component or module may also be implemented in programmable hardware devices such as field programmable gate arrays, programmable array logic, programmable logic devices, or the like. Components or modules may also be implemented in software for execution by various types of processors. An identified component or module of executable code may, for instance, comprise one or more physical or logical blocks of computer instructions, which may, for instance, be organized as an object, procedure, or function. Nevertheless, the executables of an identified component or module need not be physically located together but may comprise disparate instructions stored in different locations which, when joined logically together, comprise the component or module and achieve the stated purpose for the component or module.

Indeed, a component or module of executable code may be a single instruction, or many instructions, and may even be distributed over several different code segments, among different programs, and across several memory devices or processing systems. In particular, some aspects of the described process (such as code rewriting and code analysis) may take place on a different processing system (e.g., in a computer in a data center) than that in which the code is deployed (e.g., in a computer embedded in a sensor or robot). Similarly, operational data may be identified and illustrated herein within components or modules and may be embodied in any suitable form and organized within any suitable type of data structure. The operational data may be collected as a single data set or may be distributed over different locations including over different storage devices, and may exist, at least partially, merely as electronic signals on a system or network. The components or modules may be passive or active, including agents operable to perform desired functions.

In view of the disclosure above, a listing of various examples of embodiments is set forth below. It should be noted that one or more features of an example, taken in isolation or combination, should be considered to be within the disclosure of this application.

Example 1 is a method for automated data logging in a host vehicle, the method comprising: obtaining data from at least one sensor, the data produced during operation of the host vehicle; detecting a critical scenario from the data obtained from the at least one sensor, wherein the critical scenario is detected based on a comparison of the operation of the host vehicle to at least one requirement specified by a vehicle operation safety model; performing data extraction on the data obtained from the at least one sensor, in response to detecting the critical scenario, the data extraction to obtain data indictive of movement details of the operation of the host vehicle; and outputting the extracted data.

In Example 2, the subject matter of Example 1 optionally includes subject matter where outputting the extracted data includes storage of the extracted data in an output result buffer.

In Example 3, the subject matter of Example 2 optionally includes subject matter where the extracted data is stored in the output result buffer after removal of identifying information of the host vehicle.

In Example 4, the subject matter of Example 3 optionally includes communicating the extracted data stored in the output result buffer to a remote service.

In Example 5, the subject matter of Example 4 optionally includes subject matter where the extracted data provides information for reconstruction of the critical scenario in a simulation, wherein the extracted data indicates velocities, trajectories, or locations of a plurality of road participants involved in the critical scenario, the plurality of road participants including the host vehicle.

In Example 6, the subject matter of any one or more of Examples 1-5 optionally include buffering the data obtained from the at least one sensor in an input sensor data buffer, wherein the input sensor data buffer maintains data for a defined period of time.

In Example 7, the subject matter of any one or more of Examples 1-6 optionally include subject matter where the data is provided from at least two sensor systems provided from among: a camera mounted within an interior cabin of the host vehicle; a camera integrated within the host vehicle; a global navigation satellite system; an inertial measurement unit; or an on-board diagnostic system integrated within the host vehicle.

In Example 8, the subject matter of Example 7 optionally includes synchronizing the data provided from the at least two sensor systems.

In Example 9, the subject matter of any one or more of Examples 1-8 optionally include subject matter where the data extraction is started on data captured at a first time in which the critical scenario is determined to begin, and wherein the data extraction is ended on data captured at a second time in which the critical scenario is determined to end.

In Example 10, the subject matter of Example 9 optionally includes subject matter where the critical scenario is determined to begin based on detection of on at least one of: a longitudinal distance between the host vehicle and another vehicle being less than a defined value; a lateral distance between the host vehicle and another vehicle being less than a defined value; a lateral or longitudinal acceleration of the host vehicle being more than a threshold value; or a time-to-collision of the host vehicle with an object being less than a defined value.

In Example 11, the subject matter of any one or more of Examples 9-optionally include subject matter where the critical scenario is determined to end based on detection of on at least one of: a longitudinal distance between the host vehicle and another vehicle being more than a defined value; a lateral distance between the host vehicle and another vehicle being more than a defined value; a lateral or longitudinal acceleration of the host vehicle being less than a threshold value; or a detection of a collision of the host vehicle with an object.

In Example 12, the subject matter of any one or more of Examples 9-11 optionally include subject matter where the critical scenario is determined to begin upon detection of a violation to the at least one requirement of the vehicle operation safety model, and the critical scenario is determined to end upon elimination of the violation to the at least one requirement of the vehicle operation safety model.

Example 13 is at least one machine-readable storage medium comprising instructions that, when executed by at least one processor, cause the at least one processor to perform the methods of any of Examples 1 to 12.

Example 14 is an automated data logging system for a host vehicle, the system comprising: an interface to obtain sensing data of an environment in a vicinity of the host vehicle, the sensing data captured from at least one sensor device; and at least one processing device configured to perform the methods of any of Examples 1 to 12.

Example 15 is a vehicle, comprising an automated data logging system configured to perform the methods of any of Examples 1 to 12.

Example 16 is an automated data logging system for a vehicle, the system comprising: volatile memory to host sensing data of an environment in a vicinity of the vehicle, the sensing data produced during operation of the vehicle from at least one sensor device associated with the vehicle; non-volatile memory to host extracted data, the extracted data being a subset of the sensing data captured from the at least one sensor device associated with the vehicle; and processing circuitry configured to: detect a critical scenario from the sensing data, wherein the critical scenario is detected based on a comparison of the operation of the vehicle to at least one requirement specified by a vehicle operation safety model; perform data extraction on the sensing data, in response to detecting the critical scenario, the data extraction to obtain data indictive of movement details of the operation of the vehicle; and output the extracted data.

In Example 17, the subject matter of Example 16 optionally includes subject matter where output of the extracted data includes storage of the extracted data in an output result buffer of the non-volatile memory.

In Example 18, the subject matter of Example 17 optionally includes subject matter where the extracted data is stored in the output result buffer after removal of identifying information of the vehicle.

In Example 19, the subject matter of Example 18 optionally includes network communication circuitry configured to communicate the extracted data stored in the output result buffer to a remote service.

In Example 20, the subject matter of Example 19 optionally includes subject matter where the extracted data provides information for reconstruction of the critical scenario in a simulation, wherein the extracted data indicates velocities, trajectories, or locations of a plurality of road participants involved in the critical scenario, the plurality of road participants including the vehicle.

In Example 21, the subject matter of any one or more of Examples 16-optionally include subject matter where the volatile memory is configured to buffer the sensing data in an input sensor data buffer, wherein the input sensor data buffer maintains the sensing data for a defined period of time.

In Example 22, the subject matter of any one or more of Examples 16-21 optionally include subject matter where the sensing data is provided from at least two sensor systems provided from among: a camera mounted within an interior cabin of the vehicle; a camera integrated within the vehicle; a global navigation satellite system; an inertial measurement unit; or an on-board diagnostic system integrated within the vehicle.

In Example 23, the subject matter of Example 22 optionally includes subject matter where the sensing data provided from the at least two sensor systems is synchronized.

In Example 24, the subject matter of any one or more of Examples 16-23 optionally include subject matter where the data extraction is started on the sensing data captured at a first time in which the critical scenario is determined to begin, and wherein the data extraction is ended on the sensing data captured at a second time in which the critical scenario is determined to end.

In Example 25, the subject matter of Example 24 optionally includes subject matter where the critical scenario is determined to begin based on detection of on at least one of: a longitudinal distance between the vehicle and another vehicle being less than a defined value; a lateral distance between the vehicle and another vehicle being less than a defined value; a lateral or longitudinal acceleration of the vehicle being more than a threshold value; or a time-to-collision of the vehicle with an object being less than a defined value.

In Example 26, the subject matter of any one or more of Examples 24-optionally include subject matter where the critical scenario is determined to end based on detection of on at least one of: a longitudinal distance between the vehicle and another vehicle being more than a defined value; a lateral distance between the vehicle and another vehicle being more than a defined value; a lateral or longitudinal acceleration of the vehicle being less than a threshold value; or a detection of a collision of the vehicle with an object.

In Example 27, the subject matter of any one or more of Examples 24-26 optionally include subject matter where the critical scenario is determined to begin upon detection of a violation to the at least one requirement of the vehicle operation safety model, and the critical scenario is determined to end upon elimination of the violation to the at least one requirement of the vehicle operation safety model.

Example 28 is at least one device-readable storage medium comprising instructions that, when executed by circuitry of a device, cause the device to: obtain data from at least one sensor, the data produced during operation of a vehicle; detect a critical scenario from the data obtained from the at least one sensor, wherein the critical scenario is detected based on a comparison of the operation of the vehicle to at least one requirement specified by a vehicle operation safety model; perform data extraction on the data obtained from the at least one sensor, in response to detecting the critical scenario, the data extraction to obtain data indictive of movement details of the operation of the vehicle; and output the extracted data.

In Example 29, the subject matter of Example 28 optionally includes subject matter where output of the extracted data includes storage of the extracted data in an output result buffer.

In Example 30, the subject matter of Example 29 optionally includes subject matter where the extracted data is stored in the output result buffer after removal of identifying information of the vehicle.

In Example 31, the subject matter of Example 30 optionally includes subject matter where the instructions further cause the device to: communicate the extracted data stored in the output result buffer to a remote service. In Example 32, the subject matter of Example 31 optionally includes

subject matter where the extracted data provides information for reconstruction of the critical scenario in a simulation, wherein the extracted data indicates velocities, trajectories, or locations of a plurality of road participants involved in the critical scenario, the plurality of road participants including the vehicle.

In Example 33, the subject matter of any one or more of Examples 28-32 optionally include subject matter where the instructions further cause the device to: buffer the data obtained from the at least one sensor in an input sensor data buffer, wherein the input sensor data buffer maintains data for a defined period of time.

In Example 34, the subject matter of any one or more of Examples 28-33 optionally include subject matter where the data is provided from at least two sensor systems provided from among: a camera mounted within an interior cabin of the vehicle; a camera integrated within the vehicle; a global navigation satellite system; an inertial measurement unit; or an on-board diagnostic system integrated within the vehicle.

In Example 35, the subject matter of Example 34 optionally includes subject matter where the instructions further cause the device to: synchronize the data provided from the at least two sensor systems.

In Example 36, the subject matter of any one or more of Examples 28-35 optionally include subject matter where the data extraction is started on data captured at a first time in which the critical scenario is determined to begin, and wherein the data extraction is ended on data captured at a second time in which the critical scenario is determined to end.

In Example 37, the subject matter of any one or more of Examples 35-36 optionally include subject matter where the critical scenario is determined to begin based on detection of on at least one of: a longitudinal distance between the vehicle and another vehicle being less than a defined value; a lateral distance between the vehicle and another vehicle being less than a defined value; a lateral or longitudinal acceleration of the vehicle being more than a threshold value; or a time-to-collision of the vehicle with an object being less than a defined value.

In Example 38, the subject matter of any one or more of Examples 35-37 optionally include subject matter where the critical scenario is determined to end based on detection of on at least one of: a longitudinal distance between the vehicle and another vehicle being more than a defined value; a lateral distance between the vehicle and another vehicle being more than a defined value; a lateral or longitudinal acceleration of the vehicle being less than a threshold value; or a detection of a collision of the vehicle with an object.

In Example 39, the subject matter of any one or more of Examples 35-38 optionally include subject matter where the critical scenario is determined to begin upon detection of a violation to the at least one requirement of the vehicle operation safety model, and the critical scenario is determined to end upon elimination of the violation to the at least one requirement of the vehicle operation safety model.

Example 40 is a system, comprising: means for storing sensing data of an environment in a vicinity of a vehicle, the sensing data produced during operation of the vehicle from at least one sensor device associated with the vehicle; means for storing extracted data, the extracted data being a subset of the sensing data captured from the at least one sensor device associated with the vehicle; means for detecting a critical scenario from the sensing data, wherein the critical scenario is detected based on a comparison of the operation of the vehicle to at least one requirement specified by a vehicle operation safety model; means for extracting data from the sensing data, in response to detecting the critical scenario, wherein extraction of the data obtains data indictive of movement details of the operation of the vehicle; and means for outputting the extracted data.

In Example 41, the subject matter of Example 40 optionally includes means for storing the extracted data in an output result buffer.

In Example 42, the subject matter of Example 41 optionally includes means for removing identifying information of the vehicle from the extracted data.

In Example 43, the subject matter of Example 42 optionally includes means for communicating the extracted data stored in the output result buffer to a remote service.

In Example 44, the subject matter of any one or more of Examples 40-43 optionally include means for identifying information in the extracted data to enable reconstruction of the critical scenario in a simulation, wherein the extracted data indicates velocities, trajectories, or locations of a plurality of road participants involved in the critical scenario, the plurality of road participants including the vehicle.

In Example 45, the subject matter of any one or more of Examples 40-44 optionally include means for buffering the sensing data in an input sensor data buffer, wherein the input sensor data buffer maintains the sensing data for a defined period of time.

In Example 46, the subject matter of any one or more of Examples 40-45 optionally include means for capturing the sensing data from at least two sensor systems provided from among: a camera mounted within an interior cabin of the vehicle; a camera integrated within the vehicle; a global navigation satellite system; an inertial measurement unit; or an on-board diagnostic system integrated within the vehicle.

In Example 47, the subject matter of Example 46 optionally includes means for synchronizing the sensing data provided from the at least two sensor systems.

In Example 48, the subject matter of any one or more of Examples 40-47 optionally include means for starting data extraction on the sensing data that is captured at a first time in which the critical scenario is determined to begin, and means for ending the data extraction on the sensing data that is captured at a second time in which the critical scenario is determined to end.

In Example 49, the subject matter of Example 48 optionally includes subject matter where the critical scenario is determined to begin or end based on detection of on at least one of: a longitudinal distance between the vehicle and another vehicle relative to a defined value; a lateral distance between the vehicle and another vehicle relative to a defined value; a lateral or longitudinal acceleration of the vehicle relative to a threshold value; or a time-to-collision of the vehicle with an object relative to a defined value.

In Example 50, the subject matter of any one or more of Examples 48-49 optionally include subject matter where the critical scenario is determined to begin upon detection of a violation to the at least one requirement of the vehicle operation safety model, and the critical scenario is determined to end upon elimination of the violation to the at least one requirement of the vehicle operation safety model.

Although these implementations have been described with reference to specific exemplary aspects, it will be evident that various modifications and changes may be made to these aspects without departing from the broader scope of the present disclosure.

1. A method for automated data logging in a host vehicle, the method comprising:
obtaining data from at least one sensor, the data produced during autonomous operation of the host vehicle;
detecting a critical scenario during the autonomous operation of the host vehicle in the data obtained from the at least one sensor, wherein the critical scenario is detected based on a comparison of the operation of the host vehicle to at least one requirement specified by a vehicle operation safety model;
performing data extraction on the data obtained from the at least one sensor, in response to detecting the critical scenario, the data extraction to obtain data indictive of movement details of the operation of the host vehicle, wherein the extracted data provides information for reconstruction of the critical scenario in a simulation; and
outputting the extracted data.

2. The method of claim 1, wherein outputting the extracted data includes storage of the extracted data in an output result buffer at the host vehicle, and wherein the extracted data is stored in the output result buffer after removal of identifying information of the host vehicle.

3. (canceled)

4. The method of claim 2, further comprising:
communicating the extracted data stored in the output result buffer to a remote service, wherein the extracted data indicates velocities, trajectories, or locations of a plurality of road participants involved in the critical scenario, the plurality of road participants including the host vehicle.

5. (canceled)

6. The method of claim 1, further comprising:
buffering the data obtained from the at least one sensor in an input sensor data buffer at the host vehicle, wherein the input sensor data buffer maintains data at the host vehicle for a defined period of time.

7. The method of claim 1, further comprising synchronizing the data provided from at least two sensor systems, wherein the data is provided from the at least two sensor systems provided from among:
a camera mounted within an interior cabin of the host vehicle;
a camera integrated within the host vehicle;
a global navigation satellite system;
an inertial measurement unit; or
an on-board diagnostic system integrated within the host vehicle.

8. (canceled)

9. The method of claim 1, wherein the data extraction is started on data captured at a first time in which the critical scenario is determined to begin, and wherein the data extraction is ended on data captured at a second time in which the critical scenario is determined to end.

10. The method of claim 9, wherein the critical scenario is determined to begin based on detection of on at least one of:
a longitudinal distance between the host vehicle and another vehicle being less than a defined value;
a lateral distance between the host vehicle and another vehicle being less than a defined value;
a lateral or longitudinal acceleration of the host vehicle being more than a threshold value; or
a time-to-collision of the host vehicle with an object being less than a defined value.

11. The method of claim 9, wherein the critical scenario is determined to end based on detection of on at least one of:
a longitudinal distance between the host vehicle and another vehicle being more than a defined value;
a lateral distance between the host vehicle and another vehicle being more than a defined value;
a lateral or longitudinal acceleration of the host vehicle being less than a threshold value; or
a detection of a collision of the host vehicle with an object.

12. The method of claim 9, wherein the critical scenario is determined to begin upon detection of a violation to the at least one requirement of the vehicle operation safety model, and the critical scenario is determined to end upon elimination of the violation to the at least one requirement of the vehicle operation safety model.

13. (canceled)

14. (canceled)

15. (canceled)

16. An automated data logging system for of a vehicle, the system comprising:
volatile memory to host sensing data of an environment in a vicinity of the vehicle, the sensing data produced during autonomous operation of the vehicle from at least one sensor device associated with the vehicle;
non-volatile memory to host extracted data, the extracted data being a subset of the sensing data captured from the at least one sensor device associated with the vehicle; and
processing circuitry configured to:
detect a critical scenario during the autonomous operation of the host vehicle in the sensing data, wherein the critical scenario is detected based on a comparison of the operation of the vehicle to at least one requirement specified by a vehicle operation safety model;
perform data extraction on the sensing data, in response to detecting the critical scenario, the data extraction to obtain data indictive of movement details of the operation of the vehicle, wherein the extracted data provides information for reconstruction of the critical scenario in a simulation; and
output the extracted data.

17. The automated data logging system of claim 16, wherein output of the extracted data includes storage of the extracted data in an output result buffer of the non-volatile memory, wherein the extracted data is stored in the output result buffer after removal of identifying information of the vehicle.

18. (canceled)

19. The automated data logging system of claim 17 further comprising:
network communication circuitry configured to communicate the extracted data stored in the output result buffer to a remote service, wherein the extracted data indicates velocities, trajectories, or locations of a plurality of road participants involved in the critical scenario, the plurality of road participants including the vehicle.

20. (canceled)

21. The automated data logging system of claim 16, wherein the volatile memory is configured to buffer the sensing data in an input sensor data buffer, wherein the input sensor data buffer maintains the sensing data for a defined period of time.

22. The automated data logging system of claim 16, wherein the sensing data is provided from at least two sensor systems and is synchronized, and wherein the at least two sensor systems are provided from among:
a camera mounted within an interior cabin of the vehicle;
a camera integrated within the vehicle;
a global navigation satellite system;
an inertial measurement unit; or
an on-board diagnostic system integrated within the vehicle.

23. (canceled)

24. The automated data logging system of claim 16, wherein the data extraction is started on the sensing data captured at a first time in which the critical scenario is determined to begin, and wherein the data extraction is ended on the sensing data captured at a second time in which the critical scenario is determined to end.

25. The automated data logging system of claim 24, wherein the critical scenario is determined to begin based on detection of on at least one of:
a longitudinal distance between the vehicle and another vehicle being less than a defined value;
a lateral distance between the vehicle and another vehicle being less than a defined value;
a lateral or longitudinal acceleration of the vehicle being more than a threshold value; or
a time-to-collision of the vehicle with an object being less than a defined value.

26. The automated data logging system of claim 24, wherein the critical scenario is determined to end based on detection of on at least one of:
a longitudinal distance between the vehicle and another vehicle being more than a defined value;
a lateral distance between the vehicle and another vehicle being more than a defined value;
a lateral or longitudinal acceleration of the vehicle being less than a threshold value; or
a detection of a collision of the vehicle with an object.

27. The automated data logging system of claim 24, wherein the critical scenario is determined to begin upon detection of a violation to the at least one requirement of the vehicle operation safety model, and the critical scenario is determined to end upon elimination of the violation to the at least one requirement of the vehicle operation safety model.

28-50. (canceled)

51. At least one non-transitory machine-readable storage medium comprising instructions that, when executed by at least one processor, cause the at least one processor to perform operations for automated data logging in a host vehicle comprising:
obtaining data from at least one sensor, the data produced during autonomous operation of the host vehicle;
detecting a critical scenario during the autonomous operation of the host vehicle in the data obtained from the at least one sensor, wherein the critical scenario is detected based on a comparison of the operation of the host vehicle to at least one requirement specified by a vehicle operation safety model;
performing data extraction on the data obtained from the at least one sensor, in response to detecting the critical scenario, the data extraction to obtain data indictive of movement details of the operation of the host vehicle, wherein the extracted data provides information for reconstruction of the critical scenario in a simulation; and
outputting the extracted data.

52. The non-transitory machine-readable storage medium of claim 51, wherein outputting the extracted data includes storage of the extracted data in an output result buffer at the host vehicle, and wherein the extracted data is stored in the output result buffer after removal of identifying information of the host vehicle.
